(19) United States
(12) Patent Application Publication
(10) Pub. No.: US 2002/0033819 A1
(43) Pub. Date: Mar. 21, 2002

(54) Apparatus and method for three-dimensional scanning of a subject, fabrication of a model therefrom, and the model produced thereby

(76) Inventors: Wilbur C. Bewley JR., Nicholasville, KY (US); Roger A. Jackson, Nicholasville, KY (US)

Correspondence Address: Bruce P. Bardes, 7651 Cornell Road, Montgomery, OH, 45242, US

(21) Appl. No.: 09/954,945

(22) Filed: Sep. 18, 2001

Related U.S. Application Data
(60) Provisional application No. 60/233,907, filed on Sep. 20, 2000.

(51) Int. Cl. G09G 5/00

(52) U.S. Cl. 345/419

(57) ABSTRACT

An apparatus and method for obtaining a data file representing a three-dimensional image of the surface of a subject are disclosed. The apparatus incorporates a plurality of scanners, each comprising illuminating means and digital camera means, disposed about the subject, and computer means to correlate the images and store the data file. An apparatus and method for producing a three-dimensional model from that data file are also disclosed. The use of rapid prototyping and manufacturing technology for manufacturing a model is disclosed. The present invention is particularly applicable to human subjects.

### RELATED APPLICATIONS

Priority is claimed for this application under the provisions of 35 U.S.C. §199(e), based on Provisional Application No. 60/233,907, by Wilbur C. Bewley, Jr., filed on Sep. 20, 2000. The present application is also related to an application of even date herewith, by the applicants hereof, entitled “Apparatus and Method for Three-Dimensional Scanning of a Subject, Fabrication of a Natural Color Model Therefrom, and the Model Produced Thereby.”

### BACKGROUND OF THE INVENTION

1. Field of the Invention

This invention relates generally to fabrication of three-dimensional models of three-dimensional subjects by means that provide both exact and rapid reproduction. The invention is particularly suited for use in producing models of living subjects.

2. Description of Related Art

Ever since the first sculptor used a crude stone tool to carve an image of his neighbor from a piece of wood, man has been searching for ways to make the sculptor's task easier and less dependent upon the individual's skill. This search has produced better cutting tools, mechanically or electrically powered cutting tools, various optical devices to project images of a subject onto a workpiece, pantographs that shrink or enlarge the subject, and the like.

The development of photography created another tool that could be coupled with other tools to further lighten the sculptor's burden. Hopkins (U.S. Pat. No. 1,382,978) coupled photography, a pantograph and a motorized cutting tool with partial illumination of the subject to facilitate making a bust of a living subject. Nógrádi et al (U.S. Pat. No. 3,246,570) contributed the concept of synchronizing the rotation of both the subject and the object from which the model was being cut, to more effectively automate the sculpture process.

The Cincinnati Milling Machine Company utilized the concept of machining a model from a solid piece of material by rubbing a stylus over the surface of a subject and positioning a rotating machining tool in a manner corresponding to the location of the stylus. These were the Hydrotel milling machines that represented the state of the art in the 1950s. Hydrotel machines were useful for duplicating solid metallic subjects, and the like, but could hardly be used for duplicating a living subject. Inoue et al (U.S. Pat. No. 4,558,977) replaced the hydraulic analog control system of the Hydrotel machine with a computer-based numerical control system. However, the necessity of rubbing a stylus over the surface of the subject was common to both systems.

Yanagida (U.S. Pat. No. 5,088,864) advanced the art of photoengraving beyond what Hopkins had shown by using the output of a pair of television cameras, plus principles of solid geometry and trigonometry, to create a computer file that characterizes the three-dimensional surface of the subject. Yanagida taught that the computer file could be used to control a three-dimensional cutting machine. Yanagida taught that the subject must be carefully situated at a common focal point in the fields of view of the two television cameras. A point of the surface of the subject could be located in three-dimensional space by identifying the horizontal and vertical angular displacements of a single illuminated spot on the surface of the subject in the two television images, and performing the necessary geometric and trigonometric calculations. Yanagida's method requires extremely accurate placement of the two television cameras, in both horizontal and vertical directions; otherwise, the necessary calculations would be erroneous. The implications of this requirement are that a studio would necessarily be set up and very carefully calibrated before any computer files could be created. Further, Yanagida's teaching is directly primarily to the manufacture of bas relief likenesses of human subjects on the surfaces of medals, so the limitation that only that portion of the subject that can be viewed simultaneously by both television cameras can be reproduced in the model is inconsequential.

Hopkins, Nógrádi et al and Yanagida all teach that the surface of the subject may be partially illuminated, and the boundaries between illuminated and dark regions of the surface, viewed at some angle from the axis of the illumination, will appear as irregular shapes characteristic of the three-dimensional contour of the subject. In the context of the present discussion, any such indication of light and dark regions on the surface of the subject, caused by partial illumination thereof, will be termed a “visible fiduciary indication,” or VFI. The term will be taken to include spots of light, rectangles of light, bands of light (both parallel and intersecting) and the like. The three inventions mentioned above teach very different ways of creating and interpreting such visible fiduciary indications.

Hopkins teaches the placement of two lights, each equipped with a mask that limits illumination to a vertical half of the subject (as seen from the light), disposed symmetrically relative to a camera and a preferred angle of about 45 degrees. After taking one photograph of the subject, the subject is rotated a predetermined amount about its own vertical axis, and another photograph is taken. It its proper turn, each photograph is projected onto a screen, and a pantograph stylus is traced over the VFI. A motorized cutting tool produces a contour in the workpiece corresponding to the contour of the VFI. The workpiece is then rotated about its own axis by the same amount as the subject had been rotated between successive photographs, and the procedure is repeated. As the time required to obtain an appropriate number of photographs (Hopkins recommends 360 photographs) is considerable, apparatus to constrain the subject against moving is necessary. Similarly, repositioning the workpiece for the same number of machining cycles can be very time-consuming.

The illumination technique taught by Nógrádi et al is very similar to that of Hopkins, except that only one source of light is used. The VFIs obtained by the Nógrádi method are essentially half profiles, although they represent viewing at an oblique angle. Nógrádi et al teach that the photographic images may be used in conjunction with a light and photocell arrangement to control motion of a rotary cutting tool relative to the workpiece. Automating the reading of the VFIs represents an improvement in the state of the art.

As indicated above, Yanagida uses a single light source to create one or more VFIs on the surface of the subject, and image patterns of these VFIs are captured simultaneously by two television cameras. For his principal objective of fabricating medals, Yanagida's technique does not require movement of the subject.

Born in the mid-1980s, rapid prototyping and manufacturing (RP&M) has proven to be an extremely useful technology for making three-dimensional models of components for industrial machines. A summary of several RP&M technologies is given in a book by Lamont Wood, entitled “Rapid Automated Prototyping: An Introduction,” published by Industrial Press, Inc. in 1993. Each of the RP&M technologies has, at its heart, a process that builds up an object whose shape is defined in a computer file generated by a computer-aided drafting (CAD) program. The first of the RP&M technologies was stereolithography, described by Hull in U.S. Pat. No. 4,575,330. In this process near-surface regions of a container of photo-sensitive liquid polymer are hardened by selective exposure to high intensity light, in the form of a laser beam controlled by a computer in response to a CAD data file. Stereolithography is described in considerable detail in a book compiled and edited by Paul F. Jacobs, entitled “Rapid Prototyping and Manufacturing: Fundamentals of Stereolithography,” published by Society of Manufacturing Engineers in 1992. Another RP&M technology is selective laser sintering (SLS), invented by Deckard (U.S. Pat. No. 5,639,070). SLS technology employs a laser to selectively sinter a thin layer of powder particles together, simultaneously sintering those powder particles to an underlying substrate. Sachs et al (U.S. Pat. No. 5,204,055) have developed another RP&M technology, which they called 3D printing. In their method, a liquid binder is selectively deposited onto a layer of powder particles, to secure those particles together, pending secondary processing to strengthen the bonds between the particles. The entire RP&M industry has focused very heavily on the market for industrial parts. The presumption throughout the industry has been that engineers and designers outside the RP&M industry have created a CAD file describing some sort of industrial part, and it is the task of the RP&M industry to convert that file to tangible reality. The notion that a data file could be constructed by photoimaging is missing from that industry.

Conversely, there is no indication that Yanagida even contemplated the possibility of creating a three-dimensional object by addition of material, using some sort of RP&M technology. Yanagida's invention involves only material removal technology. Clearly, Hull's patent antedates Yanagida's invention, so it must be presumed that Yanagida had access to Hull's stereolithography technology.

### OBJECTS OF THE PRESENT INVENTION

Development of the present invention began with the identification of the shortcomings of various types of prior art methods and apparatus, as discussed in the preceding section of this specification. Once these shortcomings were identified, it was possible to establish design criteria, or objects of the invention, that avoid them. Those objects are listed hereinbelow.

It is an object of the present invention to capture images of a subject, process said images to obtain a data file, and store such a data file in its electronic format until such time as it may be used for any desired purpose, such as constructing a model therefrom, or using such a file for identifying the subject.

It is an object of the present invention to provide an apparatus and method for producing an exact three-dimensional model of a three-dimensional subject.

It is a further object of the present invention to produce a three-dimensional model of a three-dimensional subject that may be larger or smaller than the subject, but is otherwise precisely scaled to the subject.

It is another object of the present invention to be able to capture data representing a subject very rapidly, such that movement by a living subject is not a factor in producing the three-dimensional model.

It is also an object of the present invention to produce such a three-dimensional model without physically contacting the subject.

It is still another object of the present invention to produce such a model by RP&M technology, in which material is added to the model during manufacture.

It is a still further object of the present invention to provide means for modifying a data file representing a subject, such as by artistic enhancement of the subject, or combination with another data file of another subject, and the like.

Upon reading the following descriptions of the present invention and studying the accompanying drawings, these and other objects of the present invention will become apparent to one having ordinary skill in the various related arts. The following descriptions and drawings are presented with the intent of illustrating the concepts of the present invention, without limiting the scope of the present invention.

### SUMMARY OF THE INVENTION

Briefly, the present invention provides apparatus that is a combination of illumination apparatus, digital camera apparatus for obtaining a plurality of digital images of a subject, and computer apparatus for controlling the digital camera apparatus and correlating and storing the images received therefrom to create a data file. Additionally, the present invention provides rapid prototyping apparatus for constructing a model of the subject. The present invention provides a method for using this apparatus to create a data file, and to provide a model of the subject. The resulting model is a unique product of this combination of apparatus and method. The present invention that provides such a model is a heretofore unknown combination of several fields of art and technology, namely, the art of the photographer, the technology of digital camera design and use, the technology of processing digital images, the technology of correlating a plurality of digital images to construct a three-dimensional data file therefrom, and rapid prototyping technology to create a solid model from such a data file.

Development of the present invention indicated the desirability of combining an illumination unit with a digital camera unit, thus creating what is termed a scanner. A scanner can be fabricated and calibrated in a factory environment, thereby achieving great accuracy and precision in the scanner, and subsequently in determining the surface contours of the subject. A plurality of scanners is employed, to ensure that the entire surface of the subject will be represented in the computerized data file subsequently produced, without having to move either the subject or the scanner. The arrangement of the scanners is generally in a circular pattern, with other scanners disposed somewhat above and below the subject, to better capture the upper and lower aspects of the subject. Choosing the optimum number of scanners is a compromise between detail and precision of the images obtained therefrom (which is favored by a large number of scanners) and cost and processing time (which is favored by a small number of scanners). A similar compromise is needed in choosing the preferred number of pixels in the digital camera means of each scanner.

The accuracy and precision in each scanner greatly facilitates the placement of the various scanners. Unlike prior art technologies, where the placement of illumination units and photography units relative to each other is critical to the success of obtaining a three-dimensional representation of the subject, and where that critical placement must be obtained in the field, the placement of scanners in the context of the present invention is much less critical. The scanners can be calibrated by focusing then on a simple object of known configuration, such as a sphere, and then using each scanner to provide signals to a computer regarding its own location.

During development of the present invention, it was found that the scanners could easily and reliably recognize a boundary between illuminated and non-illuminated regions of the surface of the subject. A large number of such boundaries, termed VFIs, can be conveniently obtained by projecting a series of parallel bands of light onto the surface of the subject. The number of such VFIs can be effectively increased, thereby improving the resolution of the scanner, by translating the projected bands a small distance along the surface of the subject and capturing another image.

A model produced with the apparatus and according to the method of the present invention is an accurate three-dimensional representation of the subject. The model may be the same size as the subject, or it may be larger or smaller than the subject. In the context of the present discussion, the term subject is used to denote whatever object is being reproduced according the present invention. For example, the subject might be a living person. The term model is used to denote a tangible representation of the subject. For example, the model could be a bust of the subject.

The present invention provides means for capturing, correlating, processing and storing a computer data file representing the subject. Images from the several scanners employed in the apparatus must be combined to create a single data file. Computer software that combines these images can smooth out minor discrepancies in regions of the surface of the subject that were viewed in two or more scanners. Computer software can be used to modify the data file, such as by hollowing out the interior of the model, thereby reducing the amount of material consumed in producing a model. One data file may be combined with another, such as combining a data file of a living subject with a data file of a suitable base to create a data file for a bust having an integral base. The data file may also be modified in an artistic sense, so that a sculptor may create a caricature of a human subject. Because the various types of computer software that may be employed in manipulating the data files may function more effectively with differently formatted data files, conversion of the data file from one format to another may be necessary. When a data file has been processed to the full extent deemed appropriate to the particular situation, it may be stored until needed in any appropriate computer storage system. The preferred data file format for such storage will typically be dictated by the intended usage of the file. Where the next step is creating a model with RP&M apparatus, the .STL file format would be appropriate.

One object of creating a data file of a living subject may be building a library of files, such as images of children for subsequent identification in kidnapping cases, and the like. In such a situation, the file could be used to drive a holographic projector, creating a three-dimensional image of the subject. The file could also be used to create any desired number of two-dimensional photographic images, representing the photographic appearance of the subject from any desired direction. However, a more likely usage of the data file would be creating a three-dimensional model of the subject. As indicated above, that is one of the objects of the invention. One important aspect of the present invention is combining photoimaging with RP&M technology to create such models. Of the many existing RP&M technologies, that deemed best suited to the present invention is 3D printing, partly because the 3D printing apparatus is the least costly of the various types of RP&M apparatus.

Specific features of the apparatus of the present invention are detailed in the following Detailed Description of the Invention and the accompanying Figures. Specific features of the method of the present invention are also detailed in the following Detailed Description of the Invention. The preferred modes of the present invention are also described therein. Those having ordinary skill in some of the related arts will recognize alternative means of accomplishing the objects of the present invention, all of which are deemed to be equivalent to and to fall within the scope of the present invention.

### DESCRIPTION OF THE DRAWINGS

FIG. 1 is a schematic representation of the illumination and camera portion of the apparatus of the present invention. This Figure depicts the use of six scanners, specifically situated to obtain digital images of a human subject. This Figure represents the appearance of the apparatus, viewed over the left shoulder of a human subject, looking forward.

FIG. 2 is a schematic representation of a single scanner. It shows the illumination apparatus, visible fiduciary indications on the surface of the subject, and the digital camera apparatus.

FIG. 3 illustrates the operation of rapid prototyping apparatus used to fabricate the model of the present invention.

FIG. 4 represents a unitized photographic studio that combines six scanners and appropriate supports for said scanners into a single unit. This photographic studio also provides means for controlling the effects of ambient light on the scanners. This Figure represents the appearance of the apparatus looking toward a human subject's left cheek.

### DETAILED DESCRIPTION OF THE INVENTION AND PREFERRED EMBODIMENTS THEREOF

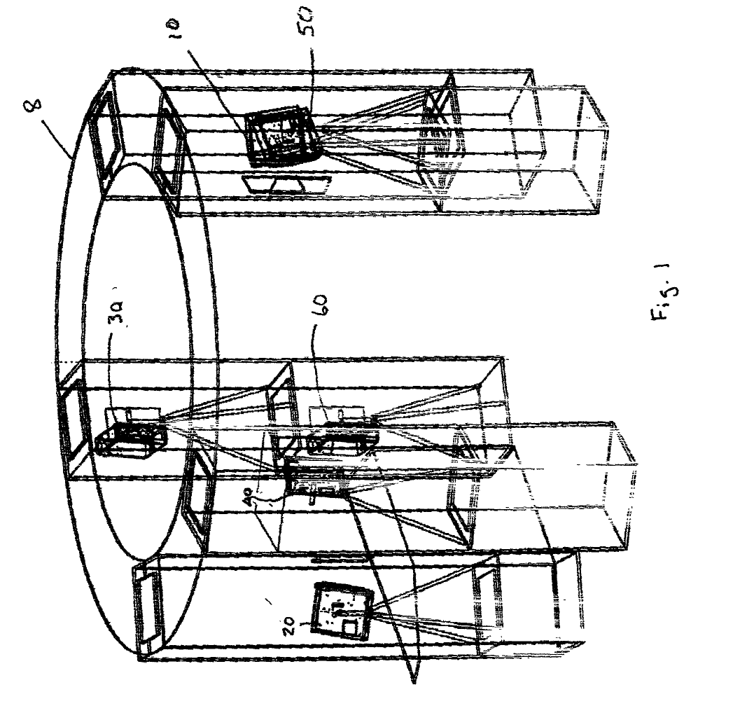

The apparatus of the present invention is advantageously described with reference to the Figures described hereinabove. The present invention is conveniently described in the context of one application therefor, namely, as means for producing a model bust of a human subject. The general layout of such an apparatus is shown schematically in FIG. 1.

As indicated above, the apparatus comprises a plurality of scanners, each comprising an illumination portion and a camera portion. The illumination portion of the apparatus may be termed a projector. The camera portion of the apparatus is preferably a digital camera. In this embodiment of the invention, six scanners are employed. The scanners are identified, by location relative to a human subject, as: 10, covering the right front portion of the subject; 20, covering the left front portion of the subject; 30, covering the top front portion of the subject; 40, covering the left rear portion of the subject; 50, covering the right rear portion of the subject; and 60, covering the lower front portion of the subject. [The directional terms in this discussion describe the positions of the scanners, relative to the subject.] Scanners 10 and 20 are preferably situated at about 10 degrees above a horizontal plane. Scanners 40 and 50 are preferably situated about 20 degrees above a horizontal plane. Scanner 30 is situated directly above scanner 60. Scanner 30 is preferably about 60 degrees above a horizontal plane and scanner 60 is preferably about 20 degrees below a horizontal plane. The scanners are situated to focus on various points of the surface of the subject. Thus, the optical centers of the scanners are not quite coincident; rather, the optical centers are separated by the dimensions of the subject being viewed.

Any convenient framework, shown generally at 8, may be employed to support the scanners and maintain their respective locations relative to each other and to the subject. A human subject is preferably seated in a chair, and the locations of the scanners are adjusted so that their respective optical centers are disposed at appropriate locations on the subject's head. When the subject is the torso of a human being, which represents another application of the present invention, the subject may stand amongst the scanners, and the locations of the scanners adjusted accordingly. For any other type of subject, any convenient device may be used to support the subject, and the locations of the scanners adjusted accordingly.

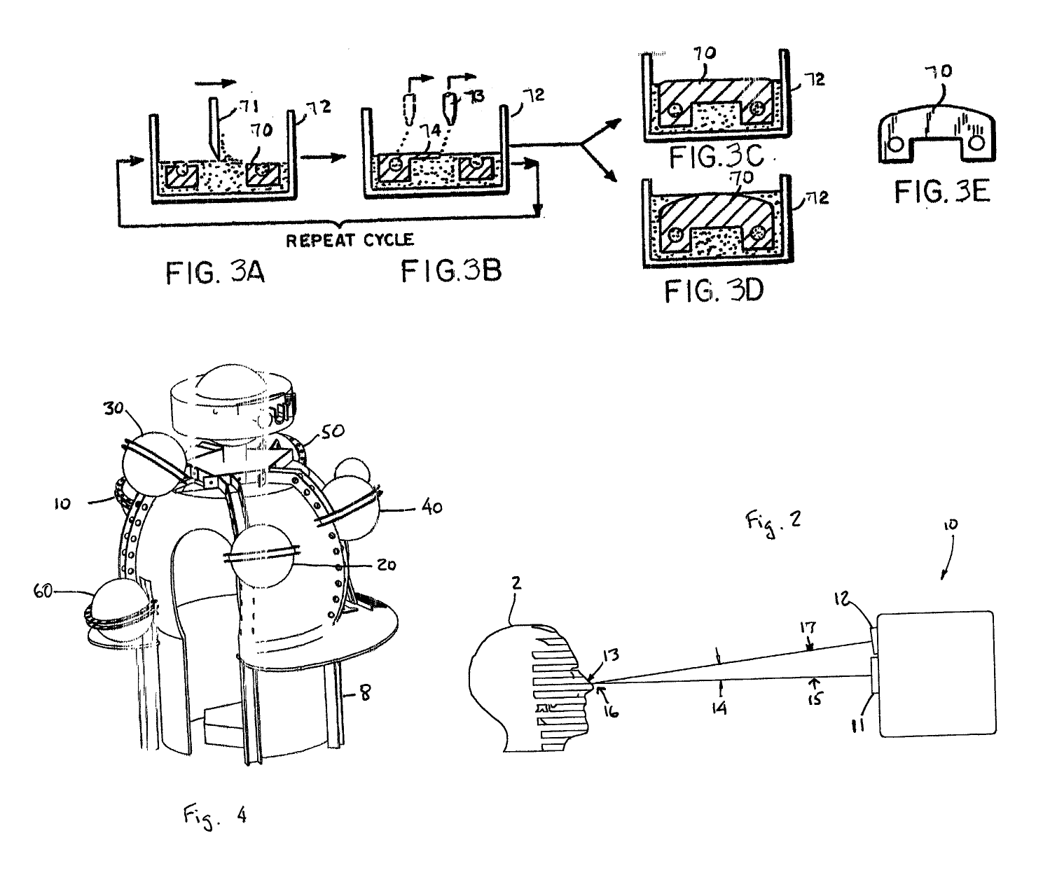

The configuration of a scanner is illustrated in FIG. 2. The scanner, shown generally at 10, is comprised of projector 11 and a digital camera 12, which are focused at the same optical center. The illuminating apparatus bathes the subject 2 with a series of parallel bands of light, which create a series of VFIs on the surface of the subject. One such VFI is shown at 13. There is an included angle 14 defined by the optical axis of the illuminating apparatus 15, the surface of subject 16 and the optical axis of the digital camera 17. By knowing the included angle, by identifying a particular VFI among those projected onto the surface of the subject, and by knowing the location of the image of that particular VFI on the sensing element within the camera, a trigonometric calculation will establish the location in space of a particular point on the surface of the subject. Such calculations are repetitively performed for other VFIs on the surface of the subject. As indicated above, additional points on the surface of the subject may be located by slightly translating the series of bands of light and repeating the process. Each of the other scanners is comprised of similar features, which may be identified as projector 21, and camera 22, comprising scanner 20, and so forth. This technique can significantly improve the optical resolution of the apparatus of the present invention without increasing the cost of the scanning apparatus.

The apparatus representing the preferred embodiment of the present is an improvement over prior art scanners because it is both faster and more accurate than prior art apparatus. The first scanner systems comprised a single laser beam, focused on a spot. This system is very accurate, but also very slow. Some means for moving either the beam or the subject was necessary to scan the entire surface of the subject. Most such means were mechanical. The next generation scanning systems comprised a laser beam deflected over a line on the surface of the subject. This system was much faster than a spot laser system, but it still required mechanical means to move the subject relative to the scanner, or vice versa. A scan of a subject typically requires more than 15 seconds.

In most of the early generation scanners, the included angle between the optical axis of the laser beam and the optical axis of the camera was about 35 degrees. Such a large angle was deemed necessary to obtain acceptable accuracy. However, such a large angle severely limits the field of view that can be covered without moving the subject relative to the scanner, or vice versa. Also, early generation scanners were comprised of separately located and mounted projectors and cameras, and such arrangements are prone to measurement errors.

The present invention is premised on the realization that an accurate and reliable three-dimensional scan of a subject can be obtained by using a plurality of scanners, wherein the position of the scanners, the orientation of each scanner and the sequence of activating each scanner in turn can be controlled to obtain a very rapid and accurate three-dimensional scan of the subject. Using the concepts and technology of the present invention, an entire three-dimensional scan can be obtained in less than about five seconds. Such rapid scanning minimizes the possibility that movement by a living subject may cause errors in the scanning process.

The preferred scanners employed in the present invention have an included angle of five degrees between the optical axes of the projector and camera. They are available from InSpeck Inc. of Montreal, QC, Canada. Such a small included angle reduces the accuracy relative to scanners having larger included angles, but the precision obtained in permanently coupling a projector and a digital camera in a factory environment reduces the impact of the small included angle. When the subject is a human being, using a small included angle facilitates the capture of the subject's hair as part of the three-dimensional image.

For obtaining images of a human being, the present invention uses at least six scanners, disposed as indicated above, and in FIGS. 1 and 4. Two scanners, shown at 30 and 60, are specifically positioned to capture the details of the face of a human subject. The scanner shown at 30, located with its optical axes about 60 degrees above a horizontal plane, captures the hairline and top of the head of the subject. The scanner shown at 60, located about 20 degrees below a horizontal plane, captures the eyes, nose, lips and chin of the subject. Scanners 10 and 20 are symmetrically disposed about the subject's face, each aimed toward the ear and cheek of a human subject. Scanners 40 and 50 are symmetrically disposed about the back of a human subject's head, with an included angle of about 90 degrees between the optical axes thereof; the optical axes of these two cameras are preferably about 25 degrees above a horizontal plane. The positions of the scanners, set forth in this paragraph, represent the presently preferred embodiment of the present invention. However, it must be recognized that considerable variation in position will not adversely affect the operation of the invention. Thus, any angular position within about plus-or-minus 30 degrees of the stated values will be deemed as lying within the spirit and scope of the present invention. For subjects other than human beings, the positions of the scanners will preferably be adjusted to best capture the contours of that subject, and the angular positions and tolerances stated above would be different.

The apparatus and method of the present invention are particularly effective in capturing the hair of a human subject. It is believed that the number and locations of the scanners, and the small included angle between the projector and camera means in the scanners, are responsible for the significant improvement over prior art technology realized in the present invention.

The scanners utilized in the preferred embodiment of the present invention have a rectangular format, 640 pixels in the horizontal direction by 480 pixels in the vertical direction. This is frequently termed a landscape format in computer jargon. However, in the context of the current invention, rotating the scanners 90 degrees about their respective optical axes provides an image that is better suited for human subjects. This format is frequently termed a portrait format. Changing the physical orientation of the scanners conforms to the general dimensions of the subject, but it also facilitates comparisons of images representing opposite sides of the subject's face for symmetry.

Detecting the VFIs in the digital camera means is most conveniently accomplished at a relatively low level of ambient light. However, the light level in the VFIs produced by the projector apparatus is a relatively bright light for a short time. The light is bright enough to cause a human subject to move, or flinch, during the image capturing process. Accordingly, it is preferred that scanners to the sides of the subject be activated before those in front of the subject, to minimize the adverse of flinching upon the accuracy of the recorded images of the subject. Thus, the preferred sequence of activating the various scanners is 10, 20, 30, 40, 50 and 60. As scanner 60 is most likely to cause a living subject to flinch, this scanner is activated last.

For human subjects, the preferred combination of images obtained from each scanner is five. The first four images are obtained using bands of light from the projector. For the fifth image, uniformly distributed white light is used. Thus, in a preferred embodiment of the invention, 30 images are captured for each subject. Five images are obtained from each of six scanners.

The software tools used for aligning the scanners, correlating the data from the various scanners and creating a data file that may be used for manufacturing a model are relatively rare in the industrial world because the need for such tools is limited to a few select industries. In the design world, software called PolyWorks is used to read data from the various scanners, to align the data and to create a file of the .STL type. PolyWorks is a product of InnovMetric Software Inc., located in Ste. Foy, QC, Canada. PolyWorks is useful for scanning the surface of a human subject, but it is not very efficient in closing off the image at the shoulders to create a bust of the subject.

In a preferred embodiment of the present invention, images are collected from six different scanners. The images are entered into and processed by PolyWorks in the following sequence: lower front scanner, shown at 60 in FIG. 1; followed by upper front scanner, 30; and left and right front scanners, 10 and 20. In this process, the latter three images may be adjusted by the software to achieve proper alignment with the lower front image from scanner 60. After these four images are properly aligned, they are treated as a single unit, to which images from scanners 40 and 50 are added, including such adjustment as may be necessary to achieve proper alignment. This sequence allows sufficient flexibility in the process of generating a data file to accommodate movement by the subject during the image-gathering sequence. Systematic changes in the extent of the adjustments needed to obtain proper alignment may be indicative of unintentional movement of one or more scanners. The same computer used for collecting and processing the images from the scanners can be used for statistical analysis of successive data sets (even though each represents a different subject) to determine whether any of the scanners has moved.

A special software package, used in conjunction with PolyWorks and other commercially available programs and the hardware portions of the apparatus of the present invention, is a novel feature of the present invention. It was developed by Inyourimage.com, of Nicholasville, Ky. specifically for this application. The software provides the following functions:

a) Control the sequence in which images are gathered from the various scanners

b) Control the locations the VFIs used in each of the scanners, as needed, to obtain more detailed images

c) Control PolyWorks software, to collect images from the various scanners

d) Align adjoining images and mate them together, and smooth the resulting composite image, so that a smooth three-dimensional image is obtained; this process may be called correlating the images

e) Complete the image by closing the bottom of the subject

f) Store the image as a computer data file, in a form suitable for input to RP&M apparatus; a commercial data base program, such as one produced by Oracle Corporation, of Redwood Shores, Calif., may be employed for this purpose

g) Verify that the image obtained is appropriate for the intended purpose

h) Perform quality assurance monitoring, and statistical analysis of such data, so that inadvertent movement of one or more scanners may be detected.

If desired, the data file developed according the method of the present invention may be modified, at the whim of the sculptor. The file may be modified to flatter the subject. The image may be deliberately distorted, such as for creating a has relief model of the subject. A base could be added to a bust of the subject. A file that adds an image of a new hairdo, or a new pair of glasses, to that of the subject could be used to show the subject his/her new appearance. The data file of the head of a child could be combined with a file describing the child's favorite action figure; it would be easy to create a file representing any particular child in an astronaut's space suit. Imageware software, available from EDS PLS Solutions, of Milford, Ohio, is particularly useful for performing the Boolean operations necessary to combine data files.

A data file may be created by a sculptor working entirely from his/her imagination. A program called FreeForm, available from SensAble Technologies, Inc., of Woburn, Mass., is useful for this purpose. Such a data file may be combined with other data files, such a one obtained by the methods of the present invention, to create a novel work of art.

The computer means employed in the present invention may be classified as a “good” personal computer, as that term was used at the time the present invention was developed. One computer employed in a preferred embodiment of the present invention possessed the following features: Pentium III processor, operating at 600 Mhz; 512 Megabytes RAM; 20 Gigabytes hard drive; video card with 64 Megabytes RAM; 20-inch monitor; read/write CD-ROM drives; and networking means for connecting the computer to the scanners and/or RP&M equipment. The video card and monitor provide 1024×768 pixel resolution to anyone viewing (or participating in) the image gathering and processing procedures. This computer system was quite adequate.

The data file containing a three-dimensional image developed according to the method described above may be utilized for several purposes. The data file may be used to drive a two-dimensional or three-dimensional projector, so that the image may be seen by humans. The file utilized in a two-dimensional projector may be functionally similar to a PowerPoint file; PowerPoint is a product of Microsoft Corporation, of Redmond, Wash. Alternatively, the file may be used to generate a photographic slide or negative. Holography technology could be employed to generate a three-dimensional image of the subject. A data file may also be processed into a computer file suitable for use as a screen saver or wallpaper, either of which could personalize one's home computer. Also, a data file may be employed to customize a video game, such that the player may see his/her own image as a game participant.

The data file may also be utilized to drive apparatus for manufacturing models of the subject. The apparatus may employ subtractive technology, in which portions of a starting workpiece are removed by machining or other suitable process, yielding a finished model. Several of the prior art references cited hereinabove illustrate subtractive technology. However old the subtractive technology itself may be, employing it in conjunction with the novel imaging and image processing technology of the present imaging represents a novel combination.

The data file may be modified to obtain a complementary model, which is described as an empty space within a solid body of matter, preferably transparent matter, such that the visible aspects of that empty space have the same shape as the subject.

The apparatus may employ additive technology, in which a model is directly created by adding predetermined amounts of material to specific regions of the model, in response to data contained in the data file. This category of technology is frequently called RP&M technology. As indicated hereinabove, there are many types of RP&M technology. It is contemplated that any form of RP&M technology may be utilized in the context of the present invention. Perhaps there is some preference among RP&M technologies, based on the intended application of the model. However, for the present application, that of making a model bust of a person, the 3D printing apparatus produced by Z Corporation of Burlington, Mass. is suitable. It has the advantage of being less expensive than most other types of RP&M apparatus. Thus, 3D printing is presently deemed the preferred RP&M technology.

This 3D printing apparatus incorporates inventions by Sachs et al, such as that cited above in U.S. Pat. No. 5,204,055, the disclosure of which is incorporated herein by reference. The principles of operation of the 3D printing apparatus may be understood in conjunction with FIG. 3. The first step is to spread a layer of powder material upon a base plate of a 3D printing apparatus 72. A liquid binder material is selectively applied to the top of the powder layer, by apparatus that is functionally similar to an ink jet printer used in conjunction with a personal computer. In regions where the binder is applied, the powder particles are bonded together to form a cohesive solid; in the absence of binder material, the powder particles remain loose and free flowing. The process is repeated, with a new layer of powder particles spread over previous layers, followed by a new application of binder, as illustrated in FIG. 3. FIG. 3A illustrates spreading powder over previously deposited workpiece material 70 using a spreader 71. FIG. 3B illustrates application of binder material through a print head 73. The portion of the powder that has been moistened by the binder material is shown at 74. FIG. 3C illustrates how the workpiece is built higher by repetition of the steps shown in FIGS. 3A and 3B. FIG. 3D illustrates the finished workpiece 70 before removal from loose powder used during the process. The finished workpiece is shown in FIG. 3E. Sachs et al teach the use of washing techniques to remove excess powder from the finished workpiece. They also teach the use of some sort of curing process to make the powder particles adhere better to each other, thereby strengthening the finished workpiece.

In the context of the present invention, additive model making (RP&M) technology is presently preferred over subtractive (machining) technology because it is less wasteful of raw materials. However, subtractive technology must be regarded as a viable alternative, fully within the scope of the present invention.

The apparatus and method of the present invention enable one to create a three-dimensional model of a three-dimensional subject by simple and convenient means. There is no need to contact the subject, for the method incorporates photoimaging technology.

FIG. 4 illustrates a unitized photographic studio that combines six scanners and appropriate supports for said scanners into a single unit. In this fanciful depiction of the studio, a space-age image for the studio is created by encasing each of the scanners in a protective shell that resembles a satellite. The scanners are supported by external ribs of the studio. A translucent shell fills the space between the ribs, except for a front entryway for the subject and a rear access hole for the operator of the studio (not shown). The translucent shell serves to control the amount of ambient light reaching the subject and also to soften shadows that may result therefrom.

As indicated above, the present invention is described in terms that relate particularly to one application thereof, capturing images of a human subject preparatory to making a bust or other model image of the subject. Certain details of the invention described hereinabove, such as locations of the scanners, represent best-mode embodiments of the invention to the extent that they have been optimized for that one particular purpose. It will be obvious to one having ordinary skill in the appropriate arts that employing the concepts and principles of the invention for other purposes may require adjusting the specific configuration of the apparatus of the invention, as described herein.

While the preferred embodiment and best mode of the present invention have been described herein in order to illustrate the principles and applications thereof, it is understood that various modifications or alterations may be made to the present invention without departing from the true scope of the invention, as set forth in the appended claims.

We claim:

1. An apparatus for creating a data file having a format amenable to processing and storage in a computer, said data file representing a three-dimensional image of at least a portion of a surface of a three-dimensional subject, said apparatus comprising:
a plurality of scanners, each of which provides means for obtaining an image of a portion of said surface of said subject; and
computer means for controlling said scanners, capturing images from said scanners in electronic form, correlating said images, creating a data file therefrom, and storing said data file;
wherein each of said scanners is comprised of:
projector means for illuminating a portion of said surface of said subject and establishing visible fiduciary indications thereupon; and
digital camera means for obtaining an image of said portion of said surface of said subject and said visible fiduciary indications thereupon;
wherein said projector means and said digital camera means are disposed such that optical axes thereof define an optical center situated at a location approximately on said surface of said subject, and an included angle having its apex coincident with said optical center;
wherein said scanners are individually and collectively disposed in locations such that collectively,
said scanners obtain overlapping images from at least a portion of said surface of said subject; and
wherein said computer means comprises both hardware and software means.

2. The apparatus as recited in claim 1, comprising at least six of said scanners.

3. The apparatus as recited in claim 2, wherein two of said scanners are disposed directly in front of said subject, two of said scanners are disposed to left and right front aspects of said subject and two of said scanners are disposed to left and right rear aspects of said subject.

4. The apparatus as recited in claim 1, wherein said scanners are disposed symmetrically with respect to said subject.

5. The apparatus as recited in claim 1, wherein said included angle on each of said scanners is less than about ten degrees.

6. The apparatus as recited in claim 4, wherein said included angle of each scanner lies in a vertical plane.

7. The apparatus as recited in claim 1, additionally comprising means for supporting said scanners and holding said scanners securely in their respective positions.

8. The apparatus as recited in claim 7, additionally comprising means for controlling illumination of said subject by ambient light.

9. The apparatus as recited in claim 1, additionally comprising means for viewing said data file stored in said computer means.

10. The apparatus as recited in claim 9, wherein said means for viewing comprises means for creating a two-dimensional image on an electronic viewing screen.

11. The apparatus as recited in claim 9, wherein said means for viewing comprises means for printing a two-dimensional representation of said data file onto a flat surface.

12. The apparatus as recited in claim 9, wherein said means for viewing comprises holographic projection means for creating a three-dimensional holographic image.

13. The apparatus as recited in claim 1, additionally comprising means for manufacturing a three-dimensional model in response to data in said data file.

14. The apparatus as recited in claim 13, wherein said means for manufacturing employs subtractive technology.

15. The apparatus as recited in claim 13, wherein said means for manufacturing employs additive technology.

16. The apparatus as recited in claim 1, wherein said computer means provides at least the following functions:
a) Controlling a sequence in which images are gathered from said scanners;
b) Controlling placement of said visual fiduciary indications on said surface of said subject;
c) Collecting images from each of said scanners;
d) Correlating said images; and
e) Storing said correlated images as a data file.

17. A method for creating a data file of a three-dimensional image representing at least a portion of a surface of a three-dimensional subject, said method comprising the steps of:
a) Disposing said subject at a location such that it is simultaneously within view of a plurality of scanners;
b) Illuminating said subject with projector means incorporated in a first scanner, wherein said projector means provides visible fiduciary indications on said surface of said subject;
c) Capturing an image with digital camera means incorporated in said first scanner, and storing said image in a computer means, in a form of an individual computer file;
d) Displacing said visual fiduciary indications and repeating steps b) and c), set forth hereinabove, as many times as may be required to obtain adequate resolution between visible fiduciary indications for said scanner,
e) Repeating steps b), c) and d) for each of the other scanners employed in said method;
f) Correlating said individual computer files to obtain said data file representing a three-dimensional image of said subject; and
g) Storing said data file in said computer means.

18. A method for manufacturing a three-dimensional model of a three-dimensional subject comprising the steps of creating a computer file, using the method as recited in claim 17, and further comprising the step of creating a three-dimensional model from data contained in said computer file.

19. A method for manufacturing a three-dimensional model of a three-dimensional subject as recited in claim 18, wherein said step of creating a three-dimensional model incorporates subtractive technology.

20. A method for manufacturing a three-dimensional model of a three-dimensional subject as recited in claim 18, wherein said step of creating a three-dimensional model incorporates additive technology.

21. A method for manufacturing a three-dimensional model of a three-dimensional subject as recited in claim 20, wherein said additive technology is a 3D printing technology.

22. A method for manufacturing a three-dimensional model of a three-dimensional subject as recited in claim 18, wherein said model is smaller than said subject.

23. A method for manufacturing a three-dimensional model of a three-dimensional subject as recited in claim 18, wherein said model is larger than said subject.

24. A three-dimensional model of a three-dimensional subject made using the apparatus as recited in claim 13.

25. A three-dimensional model of a three-dimensional subject made by the method as recited in claim 18.

26. A three-dimensional model of a three-dimensional subject, as recited in claim 25, wherein said subject is a living person.

27. The model as recited in claim 26, wherein said model provides an accurate representation of hair on said subject.
